(19) United States
(12) Patent Application Publication
(10) Pub. No.: US 2013/0180122 A1
(43) Pub. Date: Jul. 18, 2013

(54) BOOT DRYER

(71) Applicants: Rob DEARING, Jackson, WY (US); Matt BELFORD, Jackson, WY (US)

(72) Inventors: Rob DEARING, Jackson, WY (US); Matt BELFORD, Jackson, WY (US)

(73) Assignee: Dearford, LLC, Jackson, WY (US)

(21) Appl. No.: 13/548,968

(22) Filed: Jul. 13, 2012

Related U.S. Application Data
(60) Provisional application No. 61/507,466, filed on Jul. 13, 2011.

(51) Int. Cl. F26B 25/14

(52) U.S. Cl. CPC F26B 25/14
USPC 34/88; 34/218

(57) ABSTRACT

Disclosed is a drying apparatus with two separate drying units that can be attached together. The units can be attached by snap fittings, magnets, screw threads, or other attachment means. The units can further have separate or combined batteries. The incorporation of LED lighting allows for the apparatus to function as a flashlight to conserve space and weight.

### PRIORITY/CROSS-REFERENCE TO RELATED APPLICATIONS

This application claims the benefit of U.S. Provisional Application No. 61/507,466, filed Jul. 13, 2011, the disclosure of which is incorporated by reference.

### BACKGROUND

Articles of clothing, particularly boots, gloves, and socks, have a tendency to accumulate moisture and have difficulty drying efficiently without aid. This issue is caused by the technical requirements placed on the clothing, such as hard and durable boot material, water proof material, or the unique shape of a glove. The moisture issues are often compounded by the user being far from an establishment with warm conditions and electricity.

Various techniques have been used to improve drying of clothing. The utilization of fans with or without heaters is common. The prior art driers consisting of a single or separate fans to dry clothing or boots often have cumbersome cords that are not easily stored. Further, these systems incorporate only the drying function into the device. The single functionality of the prior art, and the size of the devices, renders the prior art difficult for use by persons with concerns about weight and volume, such as hunters and backpackers, because in many outdoor activities weight and bulk is a consideration, as well as availability of electricity.

### SUMMARY OF THE DISCLOSURE

The invention relates to a device for removing moisture from items such as boots and shoes. The apparatus is battery powered and features two separate dryer units in order to facilitate drying of a pair of items at one time. Each dryer unit is composed of its own housing, motor, and fan.

The dryer units can each have a separate battery compartment or share a single battery compartment. Additionally, the units can have separate or combined activating switches. Given the functional nature of the drier units, it is possible, but not required, for the units to be identical.

The dryer units can both be electrically connected to a battery pack and activation switch. Such a configuration allows for the drier units to be inside the drying target while the battery and switch remain away from area being dried.

The dryer units are designed to connect together to prevent loss of either unit and to improve portability and facilitate additional uses of the boot drying units. The dryer units can also incorporate LED units. The light emitting source can be positioned at one end of the device's connected form and run off the same power source as the dryer unit in order to perform as a flashlight.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a side view cutaway of a drying device and a view of the fan side of a drying device.

FIG. 2 illustrates multiple connection configurations of the drying apparatus.

FIG. 3 illustrates different battery connection configurations of the drying apparatus

FIG. 4 illustrates an an embodiment where two drying units are connected at the ends opposite of the fan.

FIG. 5 illustrates an embodiment where two drying units are connected at the ends housing the battery.

FIG. 6 illustrates an embodiment of the drying unit where the fan is placed within a boot and is electrically connected to a solar panel outside of the boot.

FIG. 7 illustrates an embodiment of the drying units where the units are each placed into separate boots with the power supply and activating switches remain outside, but electrically connected through a cable.

FIG. 8 is an embodiment of the drying units where each unit is placed inside a boot with one unit attached to a battery compartment with the second unit being electrically connected to the first unit via a cable.

FIG. 9 is a top view showing a battery pack and fan unit.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

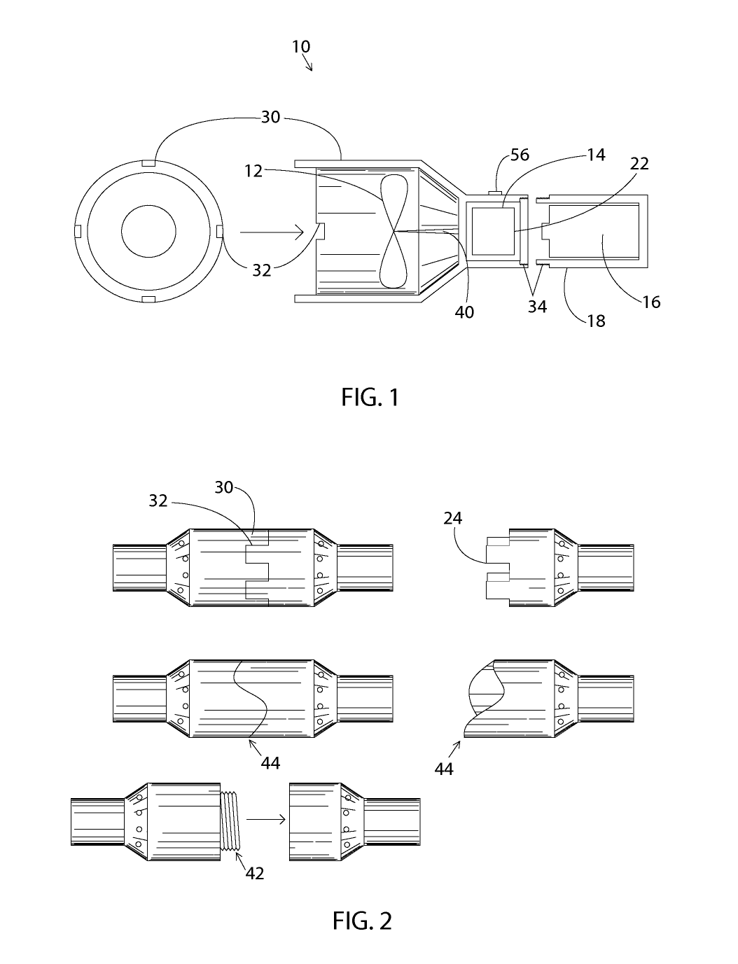

FIGS. 1 through 8 show some preferred embodiments of the disclosed technology. FIG. 1 illustrates an embodiment of the inventive concepts wherein each drying unit 10 utilizes a separate battery 16 and battery case 18. Battery 16 is held within battery case 18. Battery case 18 is attached to housing 38 by screw threads 34. Once the battery case 18 is attached, battery 16 becomes electrically connected to fan motor 14 by battery contact 22. Battery case and housing can be made of plastics, metals, or other materials being possible. Plastic or aluminum are preferred material of the battery case and housing. The system can be built to utilize several different battery sized, including AAA, AA, C, D, and CR-123 batteries for example, depending on the intended application.

The electric motor 14 delivers rotational power to fan 12 through fan shaft 40. The fan shaft 40 passes through the water tight seal 20 in order to seal the battery and motor from water which could otherwise cause damage and failure of the device.

Multiple drying units are used to dry pairs of items. These units can be connected together to prevent loss of either device and to improve portability and functionality. Drying unit 10 can be attached to another drying unit. The second drying unit can be identical to drying unit 10. Each drying unit has at least one connection tab 30 which attaches to a connection recess 32 on a second device.

FIG. 2 illustrates a second embodiment of the disclosed technology, in which the two devices can be held together using magnets 24 to aid in connection ease and strength. Further, the connection tab 30 and connection recess 32 can be replaced with other shapes and designs that allow for fastening such as screw threads 42 or the sinusoidal cut 44.

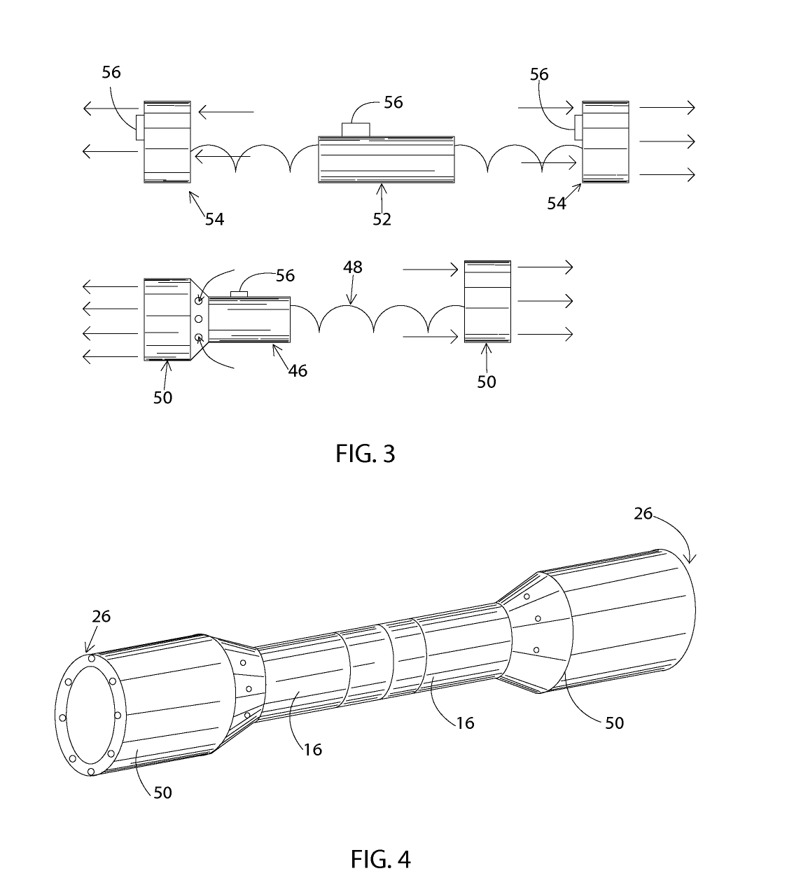

FIG. 3 further illustrates an embodiment in which the battery case 52 is not directly attached to either drying unit 54. Instead, the drying units 54 receive power from the battery case 52 via an electrical connection 28, such as a cable or wire. In this embodiment, the battery case 52 can be placed outside of the article being dried. Additionally, the activating switch or switches 56 can be on each drying unit, on the battery case, or a single switch on either the battery case 52 or either drying unit 54 can operate both devices.

In an embodiment shown in FIG. 3, the dryer units 50 use shared battery case 46. In this embodiment one dryer unit 50 is attached to battery case 46 and electrical connection 48 transfers electrical power from battery 46 to the second device. Each device can have a separate activating switch 56 or a shared switch can be used.

FIG. 4 illustrates an embodiment in which the dryer units 50 include LEDs 26. LEDs 26 are electrically connected to battery 16 so the device only requires a single battery to run either the fan motor 14 or LEDs 26.

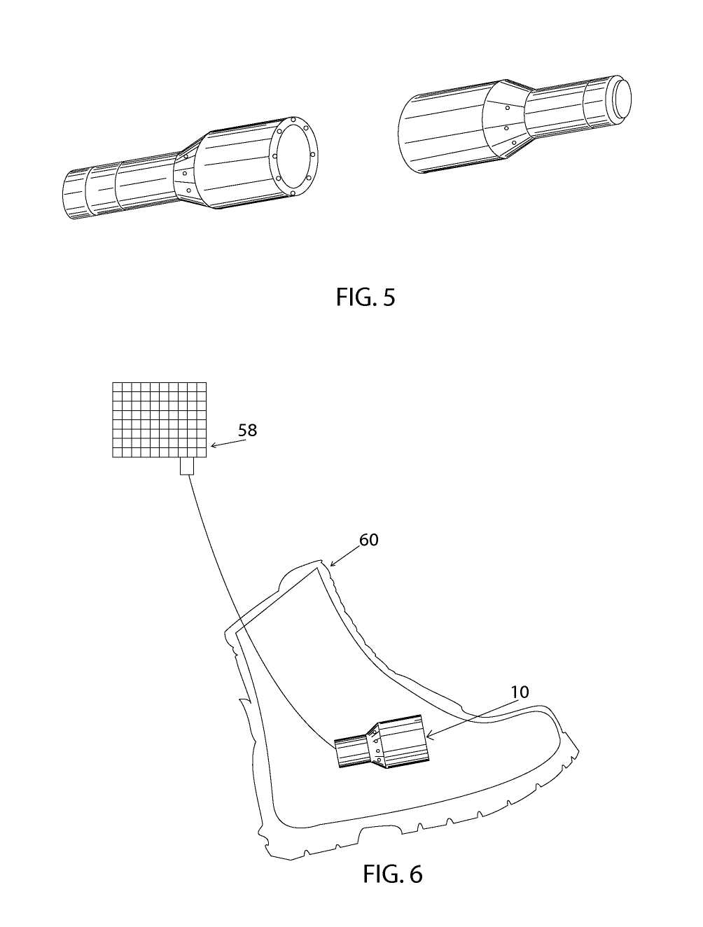

FIG. 5 illustrates another connection method in which the fans 12 and LEDs 26 are on the interior of the connected device and each individual drying unit 10 battery 16 and switch 56 pairing are on opposing sides of the connected devices.

FIG. 6 shows the use of a solar panel 58 as a power source for the drying device while the drying device 10 is within boot 60. Utilizing solar panel 58 allows for increased functionality in remote areas without requiring increased weight and bulk associated with batteries. The solar panel 58 also attaches to boot 60 to hold the solar panel 58 and heating device 10 in place.

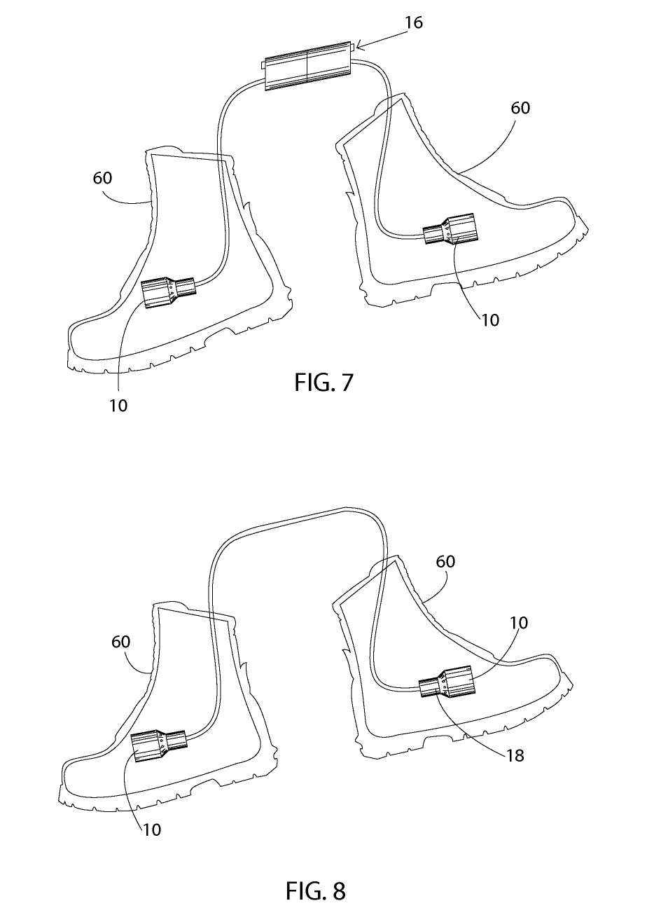

FIG. 7 illustrates drying units 10 within boots 60 while using a battery 16 for power with the battery 16 being replaceable by an AC adapter.

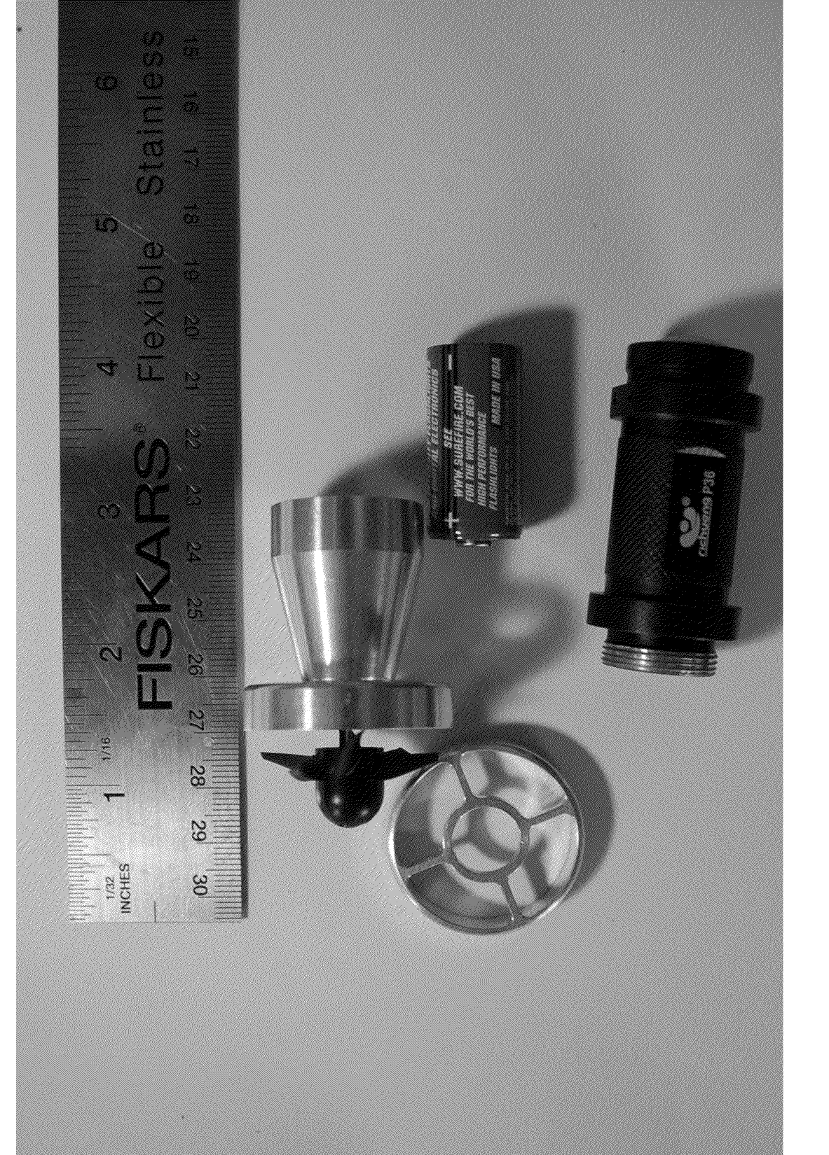

FIG. 8 illustrates the use of dryer units 10 inside boots 60. The battery case 18 is attached to one of the dryer units 10 with electrical connection 48 attaching the battery case 18 to the remote dryer unit 10.

FIG. 9 shows a preferred version of the device, with a battery case, a battery, a fan unit. The fan unit fits on one end of the battery case, and the other end of the battery case can have attached to it a second fan unit, or an LED light. If a second fan unit is attached, it can have a wire connection to the battery so one fan unit can be in a boot or shoe, and the second fan unit can be in another boot or shoe, with both fan units connected to the same battery. Alternatively, a switch unit such as made for tactical flashlights can be attached to the other end of the battery case from the fan unit. Thus the battery case can be combined with one or two fans, an LED unit, and or a switch unit.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A boot drier for removing moisture from boots and shoes, comprising:
a boot drier assembly comprising at least one battery, at least one battery compartment, at least one switch, and a first drier unit releasably attachable to a second drier unit, with each drier unit comprising a fan, a fan motor, and a fan housing with an attachment means for releasably connecting said drier units together.

2. The boot drier of claim 1 in which said first and second drier unit further comprise at least one battery in each drier unit for powering said fans.

3. The boot drier of claim 2 in which said first and second drier units further comprise a switch for activating said fan.

4. The boot drier of claim 1 in which said drier units are identical.

5. A boot drier for removing moisture from boots and shoes, comprising:
a boot drier assembly comprising a first drier unit releasably attached to a second drier unit, with each drier unit comprising at least one battery, a switch, a fan, a fan motor, and a fan housing with an attachment means for releasably connecting said drier units together.

6. The boot drier in which a single battery compartment with a switch is electrically attached to the drier units, and the drier units are placable in boots with the battery compartment outside the boots.

7. A boot drier which comprised a single battery compartment with at least one battery and at least one switch, two fan units each with a fan, a motor, and a fan housing, and further comprising an LED flashlight unit attachable to said battery compartment.
